(19) United States
(12) Patent Application Publication
(10) Pub. No.: US 2014/0377562 A1
(43) Pub. Date: Dec. 25, 2014

(54) NATURAL NANOREINFORCEMENT THAT COMPRISES A LAMINAR SILICATE FROM VOLCANIC SOURCES USEFUL TO MANUFACTURE POLYMERIC NANOCOMPOSITES AND MANUFACTURE PROCESS THEREOF

(71) Applicant: UNIVERSIDAD DE CHILE, Santiago (CL)

(72) Inventors: Patricio Toro Estay, Las Condes (CL); Raul Quijada Abarca, Vitacura (CL); Mehrdad Yazdani-Pedram Zobeiri, Nunoa (CL)

(21) Appl. No.: 14/368,926

(22) PCT Filed: Nov. 20, 2012
(86) PCT No.: PCT/IB2012/056569

§ 371 Date: Jun. 26, 2014

(30) Foreign Application Priority Data
Dec. 28, 2011 (CL) 3334-2011

(51) Int. Cl. C08K 3/34; C04B 33/30

(52) U.S. Cl. CPC C08K 3/34; C04B 33/30
USPC 428/402; 501/149

(57) ABSTRACT

The invention discloses a nanoreinforcement to produce polymeric nanocomposites from a natural laminar silicate from volcanic sources. The invention also discloses the manufacture process and use thereof to obtain polyolefin nanocomposites useful for the automotive, aerospace, construction and packaging industries, among others.

### OBJECTIVE OF THE INVENTION

The present invention comprises sodium montmorillonite-like natural nanoreinforcements that comprise a laminar silicate of volcanic origin in its basic structure and a manufacturing process for said nanoreinforcements. This smectite- or phyllosilicate-like nanoreinforcement has physicochemical features that make it suitable to be used as a reinforcement material in polymeric matrixes of the thermoplastic, thermostable or elastomeric types, comparable to those of commercially available montmorillonite- or clay-like silicates. The manufacturing process comprises a wet treatment using only two analytical-grade chemicals as deflocculant-flocculant providing high yields of natural nanoreinforcement particles of the phyllosilicate type such as sodium montmorillonite and particle size lower than two microns. The elemental composition of the volcanic silicate is free from heavy and noxious metals. The process used for the production of the natural nanoreinforcement does not alter its elemental composition, and thus this natural nanoreinforcement can be used as reinforcement for polymeric nanomaterials in applications where the content of characteristic elements at low concentrations is relevant. These characteristic elements in the natural nanoreinforcement is lower, for the same elements, than in commercially available silicates or clays. The natural nanoreinforcement disclosed in this invention can be treated with methods similar to those used with commercially available silicates or clays to be subsequently applied as nanoreinforcement in polymeric matrixes. Additionally, this natural silicate has a high purity degree that also facilitates the manufacturing of high-purity polymeric nanomaterials. Besides presenting a process to manufacture this nanoreinforcement from a natural volcanic silicate, the invention also includes a process to manufacture polymeric nanomaterials using the nanoreinforcement of this invention and polymeric nanomaterials using commercially available silicates or clays, in order to compare the mechanical and thermal behavior of both nanomaterials.

The natural nanoreinforcement manufactured according to the process of this invention has the crystalline structure of a laminar silicate, with an interlamellar spacing in the nanometer range and specific surface comparable to that of commercially available silicates or clays used as nanoreinforcements for polymeric matrixes. Furthermore, the raw material used in this process is a natural silicate with a volcanic origin and a mineral composition mainly containing montmorillonite, quartz and feldspar. The process of this invention allows producing in high yields a natural nanoreinforcement mainly containing the montmorillonite mineral component, removing other mineral components such as quartz and feldspar in an efficient way. Hence, this process ensures the production of a natural nanoreinforcement of the phyllosilicate type such as sodium montmorillonite, corresponding to the mineral composition of the commercially available silicate- or clay-like nanoreinforcements currently used in the technological development of polymeric nanocomposites.

Furthermore, the process of this invention produces a nanoreinforcement that fulfills the requirement of granulometric dimensions lower than two micrometers in diameter typical of particles of a mineral silicate or clay. The natural silicate used as a raw material for this process has a granulometric distribution with particle sizes larger than two micrometers, and the process of this invention efficiently removes the large-size particle fraction.

The process of this invention produces a laminar silicate nanoreinforcement with a crystalline structure, with a hydrophilic interlamellar space due to the presence of interlamellar cations. In other words, the process of this invention provides a nanoreinforcement able to exchange interlamellar cations in order to substitute them by other cations, such as for instance organic cations, and thus the interlamellar characteristics can be modified from hydrophilic to hydrophobic. The silicate thus modified is called hybrid silicate or clay and has a hydrophobic character.

Consequently, this hybrid silicate is able to homogeneously intermix or disperse with a polymer due to the similarity in hydrophobic character. Additionally, the interlamellar space of the hybrid silicate of this invention is increased with respect to the original silicate without modifying the purity or crystallinity thereof. Hence, the mixture of this hybrid silicate with a polymer generates a polymeric nanocomposite with interspersed or exfoliated structure, depending to the nature of the interlamellar hydrophobic groups and the polymer. Both types of nanocomposite configuration are alternatives of the nanostructure between the hybrid clay and the polymer that will finally govern the properties of the polymeric nanocomposite thus obtained. Accordingly, the process of this invention allows obtaining a nanoreinforcement from a natural volcanic silicate with the physicochemical properties required to be used in the manufacture of reinforced polymeric nanocomposites using current technological production procedures.

Finally, the natural nanoreinforcement produced by means of the process of this invention is a smectite- or sodium montmorillonite-like phyllosilicate and consequently is a novel alternative natural material to be used as a reinforcement material for polymeric matrixes through processes as those described by the authors of this invention in the patent “Hybrid clay for nanocomposite manufacturing comprising a smectite clay interspersed with monomeric itaconic acid and/or a derivative thereof; process to manufacture the hybrid clay and use thereof to manufacture polyolefin nanocomposites by melt mixing”, CL 2730/2006, Record No. 47385.

The present invention describes a reproducible and efficient process to remove particles larger than two microns from a volcanic natural silicate, without altering the structure or purity of the raw material, isolating the montmorillonite mineral component to manufacture natural laminar nanoreinforcements for application as reinforcement in polymeric matrixes. The natural nanoreinforcement provided by the process of this invention is a novel and alternative material different from the commercially available materials that can be used to improve mechanical, thermal and barrier properties of polymeric nanocomposites.

### TECHNICAL FIELD

Smectite-like silicates or clays such as montmorillonite and hectorite are laminar phyllosilicate clays and share some structural characteristics with minerals such as talc and mica. Phyllosilicates have a structure based on the stacking of planes formed by oxygen and hydroxyl ions. Tetrahedral (SiO)₄⁴⁻ groups are joined sharing three of their four oxygen atoms with other neighbors to form layers with infinite extension and formula (Si₂O₅)²⁻, which constitute the fundamental phyllosilicate unit. Tetrahedrons are distributed in these layers forming hexagons. Tetrahedral silicon can be partly substituted by Al³⁺ or Fe³⁺.

These tetrahedral layers are joined to other gibbsite- or brucite-like octahedral layers. In these layers, some Al³⁺ or Mg²⁺ atoms can be replaced by Fe²⁺ or Fe³⁺ and more rarely by Li, Cr, Mn, Ni, Cu or Zn. The plane joining both layers is formed by the oxygen atoms in tetrahedrons that are not shared with other tetrahedrons (apical oxygens) and by (OH)⁻ groups of the gibbsite or brucite layer, in such a way that in this plane a (OH)⁻ group is in the center of each hexagon formed by 6 apical oxygens. The remaining (OH)⁻ groups are replaced by the oxygens in tetrahedrons.

In some phyllosilicates (smectites, versiculites and micas, among others), the lamellae are not electrically neutral due to the substitution of some cations by other cations having a different charge. The charge balance is maintained by the presence in the interlamellar space (the space existing between two consecutive lamellae) of cations (such as for instance in the mica group), hydrated cations (such as in vermiculites and smectites) or octahedrically-coordinated hydroxyl groups similar to octahedral layers, as in chlorites. The unit formed by one lamella plus the interlamellar space is the structural unit. The most frequent interlamellar cations are alkaline (Na and K) or alkaline earth (Mg and Ca).

The polymers that contain lamellar silicates are widely used as alternative or replacing materials for steel or other metal products, especially in the aerospace, automotive, construction and electric appliance field. These polymeric materials or nanocomposites are used in a growing number of other areas including bridge components, as well as replacements for heavier steel pieces, such as in the construction of marine vessels. For example, extrusion and injection molding have successfully reinforced a nylon matrix reinforced with hybrid silicates or clays such as montmorillonite, bentonite or hectorite. The dispersion of these hybrid clays in a polymeric matrix provides a clay/polymer nanocomposite with mechanical, thermal, dimensional stability, barrier, etc. properties directly depend on the dispersion grade of said clays in the polymeric matrix. This is attributed to the confinement of the matrix chains between the innumerable lamellae of the clay. Furthermore, montmorillonite, bentonite and hectorite are clays composed by planar silicate lamellae with a thickness in an approximate one-nanometer range. These nanocomposites find important commercial application not only in the synthesis and properties of the abovementioned organic/inorganic nanostructure, but also in diverse areas such as in ultrathin polymeric layers.

Organically modified silicates or hybrid clays produced by cationic exchange reaction between the clay and a quaternary ammonium or alkylammonium salt are used in the preparation of nanocomposites. Cations from the alkyl group are interspersed between the lamellae of the natural clay, thus producing the organophilic or hybrid clay, and this transformation makes the clay more hydrophobic and more easily dispersible in apolar polymers.

### PREVIOUS ART

The first scientific work using a hybrid clay or modified laminar silicate for the preparation of nanocomposites is reflected in the U.S. Pat. No. 2,531,396. This patent, filed on 1947, describes the use of organically modified bentonites to provide structural reinforcement to elastomers such as rubber, polychloroprene and polyvinyl compounds. Several patents granted in 1984, for instance the U.S. Pat. Nos. 4,472,538; 4,810,734; 4,889,885 and 5,091,462 use hybrid clays for polymers and describe the use of commercial structural plastics, e.g. to replace steel components in cars.

The manufacturing of nanocomposites also includes the mixture of clay with a powdered polymer, which is pressed to produce a pellet and heated up to a suitable temperature. For instance, polystyrene has been interspersed by mixing polystyrene and montmorillonite and heating under vacuum. The temperature is chosen in such a way as to be higher than the vitreous transition temperature of polystyrene in order to ensure the melting of the polymer.

The U.S. Pat. No. 4,810,734 describes a different process to produce a nanocomposite that comprises a step of contacting a clay with a cationic exchange capacity of 200 milliequivalents per 100 g with a swelling agent in a dispersion medium, forming a complex having the property of swelling with the monomer (e.g. an amino acid for a polyamide, vinyl chloride for vinyl polymers, and the like) and subsequently polymerizing the monomer in the mixture. The U.S. Pat. No. 4,889,885 describes a nanocomposite that comprises at least one resin selected from the group consisting of a vinyl based polymer, a thermostable resin and a rubber, and laminar bentonite uniformly dispersed within the resin, wherein the laminar silicate has a layer thickness ranging around 7 to 12 nm and a interlamellar distance of at least 30 nm, wherein at least the resin is connected to one silicate lamella by means of an intermediary.

Many of the products described in the above cited references describe the problem that the products are easily processed and isolated, but are difficult to be dispersed in a polymeric matrix. Moreover, these materials do not show good compatibility with certain plastic materials.

The U.S. Pat. No. 5,552,469 describes the use of a clay by interspersing with a water-soluble polymer, but presents problems related to the isolation of the clay in the aqueous phase. The isolation of the clay was only possible from the aqueous solution at 100° C. A mixture of clay and monomer was subjected to polymerization by forming a nanocomposite in situ, and the clay is well dispersed in the polymer. Unfortunately, this technique is a highly costly polymerization process and the production plant is contaminated with clay.

Recent invention patents (WO 2010/146216m US-2009/7625985, US 2008/0039570, US-2000/6050509) have shown the interest for the development of processes to manufacture nanocomposites using clays from different sources and even natural sources, with the aim of optimizing the compatibility with polymeric matrixes and thus obtaining nanocomposites.

The present invention describes a process to obtain a natural nanoreinforcement using a natural volcanic silicate with laminar character as a raw material. This process is applied to a mixture of natural volcanic silicates to provide a nanoreinforcement compatible with polymeric matrixes that has not been previously described in the abovementioned patents or in scientific publications. Furthermore, it is applied to manufacture nanocomposites using organic compounds also called compatibilizers, which are compounds that make the dispersion of laminar silicates in polymers easier. All this is achieved using simple melting processes that are reproducible and lead to nanocomposites with improved mechanical, thermal and barrier properties.

The present invention discloses a nanoreinforcement and a reproducible, sustainable and high-yield manufacture process to produce a nanoreinforcement that comprises in its base structure particles of a natural volcanic silicate with laminar structure of the smectite type and comprising the phyllosilicate montmorillonite as its only mineral component. The process of the invention consists on an effective particle fractioning of the natural silicate by using high purity reactants as deflocculant-flocculant in an aqueous medium at room temperature, which allows enriching the particle fraction lower than two micrometers in size. The process of the invention is applicable to raw materials such as natural silicates with a multimodal granulometric distribution ranging from 0.15 to 100 micrometers, and a mineral composition including a mixture of montmorillonite, quartz and feldspar among other minerals. The natural phyllosilicate obtained using the process of the invention can be applied as nanoreinforcement in polymeric matrixes to manufacture polymeric nanocomposites with improved mechanical, thermal and barrier properties in comparison to the same commercially available materials with nanoreinforcements. Furthermore, the invention discloses a procedure to prepare nanocomposites from the fractionated natural silicate of the invention, in order to compare their properties with those of nanocomposites that use commercial nanocomposites. The nanocomposites produced by the process of the invention can be applied in the automotive, electronic, construction, and home appliance industries, and thanks to the natural clay elemental composition free from heavy metals, can also be applied as nanoreinforcement in the medicine, food and like areas.

### Definitions

For a better understanding of the invention, we define the following:
1. Hybrid silicate: silicate modified or interspersed with organic compounds such as quaternary salts of organic amines.
2. Deflocculant: chemical compound that agglutinates micrometric solids in suspension.
3. Flocculant: chemical compounds that improve the settling and clarification of suspensions of micrometer-sized solid particles.
4. Nanocomposite: material formed by one component of nanometer-sized particles within a macroscopic component such as a polymeric matrix.
5. Polymer: organic compound consisting in structural units that are repeated innumerable times and are connected by covalent chemical bonds.
6. Polyolefin: polymer obtained by catalytically polymerizing ethylene, propylene or other olefins, as well as copolymers of these olefins with alpha-olefins.
7. Compatibilizer: organic compound that allows two or more chemical substances to mix without segregation, such as a polymer and nanometric particles.
8. Polydispersity: index for the variation degree or amplitude of a Gaussian bell representing the molecular weights of a polymer.
9. Masterbatch: material formed by a polymer and a particulated additive with a high additive proportion. Hence, this material is a base to obtain other materials with a lower proportion of the same additive. In other words, e.g. it can be a Masterbatch of polymer and laminar silicate nanoparticles to produce a nanocomposite of polymer and laminar silicate.

### DESCRIPTION OF THE DRAWINGS

FIG. 1: X-ray diffraction pattern showing the intensity in arbitrary units vs. the two-theta angle in degrees for the natural silicate and the nanoreinforcement of this invention.

### DETAILED DESCRIPTION OF THE INVENTION

Specifically, this invention comprises a natural nanoreinforcement and a process to manufacture said nanoreinforcement, such as, e.g. a laminar silicate of the smectite or sodium montmorillonite type. This natural nanoreinforcement is particularly characterized by being obtained from a natural silicate from a volcanic source having a mineral composition including a mixture of the phyllosilicates montmorillonite and illite, as well as quartz, plagioclase, feldspar, clinoptilolite and amphiboles. The natural silicate has a granulometric distribution ranging from 0.35 to 53 micrometers in particle size, with a fraction smaller than 2 micrometers ranging from 40-50% by weight and a fraction between 2 and 50 micrometers ranging from 30-39% by weight. The natural silicate elemental composition contains elements such as silicon, aluminum, sodium, lithium, iron, magnesium, calcium and potassium mainly, and is free from arsenic and heavy metal elements such as chromium and lead. Furthermore, the natural silicate has a laminar structure with an interlamellar space having a hydrophilic character due to the presence of cations such as sodium and/or calcium or magnesium in the intergalleries, and has a interlamellar distance in the range between 1.10 and 1.35 nanometers.

The method to manufacture the natural nanoreinforcement from the volcanic laminar silicate of this invention considers the use of an analytical-grade deflocculating compound to extract with a high yield the fraction of particles larger than two micrometers in particle size contained in the natural silicate. In this way, this nanoreinforcement has the particle size characteristics of a clay-like silicate, i.e. smaller than two micrometers. Furthermore, the method allows obtaining a nanoreinforcement with the same elemental composition of the natural silicate raw material, without incorporating new metallic elements due to the use of an analytical-grade chemical compound as a deflocculant. Additionally, this nanoreinforcement has a mineral composition that includes mainly the phyllosilicate sodium montmorillonite. The method of this invention removes the other mineral components of the mixture containing the natural silicate. Moreover, the nanoreinforcement obtained using the method of this invention has improved physicochemical properties such as larger specific surface (m²/g) and cation exchange capacity (milliequivalents/100 grams) in comparison with the natural silicate used as a raw material in this invention process.

Furthermore, the present invention discloses the use of this nanoreinforcement to manufacture polyolefin nanocomposites and also describes the manufacture process.

The process to obtain the polymeric nanocomposites or nanomaterials considers using standardized methodologies of current polymeric nanomaterial technology developments that can be applied to the nanoreinforcement of this invention. In other words, this implies the treatment of the nanoreinforcement to modify its hydrophilic character by the efficient replacement of interlamellar cations with organic cations such as quaternary amines or other compounds such as dicarboxylic acids or their derivatives, in such a way as to obtain a nanoreinforcement with hydrophobic character. Under these conditions, the mixture of this modified nanoreinforcement comprising a hydrophobic hybrid silicate with the polymer is more viable. Besides, with the additional help of polymeric compounds grafted with polar molecules, i.e. the compatibilizers, a high interspersing or exfoliation of the nanoreinforcement in the polymeric matrix is achieved.

The procedure to manufacture these polymeric nanocomposites from a phyllosilicate-like nanoreinforcement (montmorillonite) and polyolefins applied in this invention uses procedures as the one described by the authors of this invention in other invention patents (“Hybrid clay for nanocomposite manufacturing comprising a smectite clay interspersed with monomeric itaconic acid and/or a derivative thereof; process to manufacture the hybrid clay and use thereof to manufacture polyolefin nanocomposites by melt mixing” (CL 2730/2006, Record No. 47385), and “Polyolefin compatibilizer comprising polypropylene grafted in melted phase with itaconic acid with a grafting degree ranging from 0.5 to 2.8%, with a reproducibility level lower than 10% and with no polypropylene degradation; manufacture process and use of the compatibilizer” (CL 2729-2006)), which comprises in a first step modifying the natural nanoreinforcement replacing exchangeable cations from this nanoreinforcement by quaternary aliphatic amine cations, in a second step mixing in melted phase the modified nanoreinforcement with a compatibilizer to obtain a primary mixture or Masterbatch and finally diluting this Masterbatch with pure polymer to obtain the polymeric nanocomposite.

The nanocomposites manufactured in this way are characterized by having improved mechanical and thermal properties with respect to the nanocomposites prepared using nanoreinforcements of the current commercially available clay or phyllosilicate type nanoreinforcements and different to those developed in this invention.

The description of this invention considers:
1. Production of a nanoreinforcement that comprises the use of a volcanic natural silicate, to be applied in the manufacture of polymeric nanocomposites.

The methodological procedure to obtain the nanoreinforcement using the natural volcanic raw material comprising a laminar silicate comprises a treatment that allows, on the one hand, removing the fraction with a particle size larger than two micrometers in the volcanic natural silicate, and on the other hand, isolating the mineral component such as the phyllosilicate montmorillonite. These characteristics, i.e. particle size smaller than two micrometers and mineral composition of the phyllosilicate montmorillonite in high levels, comprise properties required for silicate-like nanoreinforcements for polymeric matrixes that are used in the current polymeric nanomaterial development. In this way, the process of this invention comprises, in general, a wet granulometric fractioning of the natural volcanic silicate. This process uses the addition of an analytical grade deflocculant to an aqueous suspension of the natural silicate. In this way, it is possible make the natural silicate particles to deagglomerate and additionally, by gravity action, particles of different sizes could attain an equilibrium where the particle size distribution in the aqueous suspension of the natural silicate is given by the height of the containing vessel. That is, the higher the height the smaller the diameter, by action of gravity in the deagglomerated particles with different sizes. This condition is facilitated by an efficient deflocculant action and also by mechanical stirring followed by cavitation produced by treating the suspension with ultrasound. In this way, a maximum separation of particles in the aqueous suspension can be achieved. Subsequently, it is left to stand for enough time to achieve a physical equilibrium of particles by size in the suspension. Finally, the fraction of the aqueous suspension corresponding to particles in the top section of the containing vessel, i.e. smaller size particles, is removed. An analytical-grade flocculant is added to this extracted fraction in order to facilitate the separation of these smaller size particles by centrifugation of the extracted suspension. This granulometric fractioning process in aqueous medium is performed in repeated consecutive cycles with the remaining natural silicate suspension, in such a way as to achieve a high yield in weight of smaller size particles.

The control of this wet granulometric fractioning process of the natural silicate is carried out by determining the weight yield of each separation cycle for lower size particles from the extracted aqueous suspension, as well as the physicochemical properties of the separated solid particles. Among the properties to be determined as a process control, we consider:
i) granulometric analysis to verify the efficiency of the procedure to separate smaller size particles;
ii) determination of the specific surface (m²/g) of extracted particles as an additional control of the size of smaller size particles (the specific surface increases with a decrease in particle size if there is no microporosity change),
iii) crystallographic analysis by X-ray diffraction to verify the efficiency of the procedure used in this invention to separate the mineral component of the phyllosilicate sodium montmorillonite from other mineral components, as well as testing the crystallinity degree and laminar morphology,
iv) elemental composition analysis of the extracted particles to verify the method efficiency as for not altering the elemental composition of the raw material by addition of the analytical-grade chemicals (deflocculant and flocculant) used, and
v) determination of the Cationic Exchange Capacity (CEC) to verify that the smaller size particles extracted using this methodology has a required CEC level for a suitable nanoreinforcement to produce polymeric nanocomposites.

Besides, it must be emphasized that the nanoreinforcement obtained by means of this invention uses a volcanic natural resource as a raw material, and it has the physicochemical characteristics required for polymeric matrixes nanoreinforcements, i.e. for the manufacture of polymeric nanocomposites.
2. Procedure to manufacture polymeric nanocomposites using the nanoreinforcement of this invention.

The methodology applied in nanotechnology to polymer based nanomaterials with laminar silicates of the smectite type, such as montmorillonite, is used to manufacture polymeric nanoreinforcements that use the nanoreinforcement of this invention. In this way, when assessing that the nanoreinforcement of this invention can be mixed with polymeric matrixes such as polyolefins to elaborate nanocomposites with a similar structure and improved properties in comparison to the same composites using silicate-type nanoreinforcements such as montmorillonite is a further prove of the efficiency of the process of the invention to manufacture nanoreinforcements from a new raw material such as a natural volcanic silicate.

The used procedure considers, in general, a first step wherein the hydrophilic character of the interlamellae of the nanoreinforcement or phyllosilicate of the invention is modified by interlamellar cation exchange with quaternary salts of, for instance, O₂ to O₂₀ carbon chain aliphatic amines, in an aqueous acid medium. In this way, the hydrophilic character of the interlamellar space of the nanoreinforcement changes to hydrophobic character, i.e. the same character of apolar polymers such as polyolefins. In a second step, to optimize the formation of the nanocomposite based on polyolefin and modified nanoreinforcement or hybrid hydrophobic silicate, a primary mixture or Masterbatch of hybrid silicate and a polyolefin-based compound, such as e.g. homopolymeric polypropylene with a fluidity index ranging from 1 to 20, grafted with polar molecules, such as e.g. maleic anhydride or itaconic acid or its derivatives, called a compatibilizer, is formed. This pre-mixture or Masterbatch is obtained by mixing its components in melt state. Finally, the polymeric nanocomposite is obtained by dilution of this Masterbatch with more pure polymer by means of a melt state process, to achieve the nanoreinforcement composition required in the nanocomposite, which comprises around 1 to 10% by weight in content.

The control of this process considers the consolidation assay of the polymeric nanocomposite using the nanoreinforcement of this invention and the assay of the same improved morphologic characteristics and thermal, mechanic and barrier properties when compared to the same polymeric nanocomposites that use commercially available silicate-based nanoreinforcements.

Hence, the invention comprises:
A natural nanoreinforcement useful to manufacture polymeric nanocomposites that comprises in its basic structure a laminar silicate from volcanic sources.
A procedure to manufacture said nanoreinforcement using natural volcanic silicate with laminar structure as a raw material (Procedure 1).
Use of the nanoreinforcement of the present invention to obtain polyolefin-based nanocomposites (Procedure 2).

### Procedure 1

Manufacture of a nanoreinforcement using natural volcanic silicate with laminar structure as a raw material.

This comprises the following steps:
a) preparing a volcanic natural silicate aqueous solution (5-12 g in 600-700 ml of deionized water) with mechanical stirring for 10-20 minutes at 18-23° C. (suspension 1).
b) adding 20-30 ml of a deflocculant such as analytical-grade sodium hexametaphosphate (0.4-0.6 mol/l) to suspension 1, continuing with the mechanical stirring for 20-30 minutes, followed by sonication (5-10 minutes) of suspension 1 with deflocculant (suspension 2),
c) repeating four to six times the cycle of mechanical stirring for 20-40 minutes followed by sonication (10-20 minutes) of suspension 2,
d) transferring the suspension 2 after finishing the agitation and sonication cycles to a graduated cylindrical glass beaker, adding deionized water to complete a total 1-litre volume, mechanically stirring (5-10 minutes) to homogenize the solution and leaving the solution to stand for 21-24 (suspension 3),
e) extracting by suction the top fraction of suspension 3 corresponding to 20 cm measured from the top level of the 1-liter beaker (suspension 4),
f) adding 20-30 ml of an aqueous solution of a flocculant compound such as magnesium chloride (0.3-0.6 mol/l) to suspension 4, mechanically stirring for 20-30 minutes, and leaving to stand for 20-30 minutes (suspension 5),
g) separating the suspended solids in suspension 5 by centrifugation at 4000-5000 rpm for 3-5 minutes and drying the solid at 100-120° C. for 20-25 hours, h) disaggregating the dry solid from step g) using a blade mill and sieving through a standard 250 micrometer mesh (Test Sieve ASTM E-11).

Nanoreinforcement particles corresponding to the granulometric fractioning of the natural volcanic silicate, i.e. the finest size fraction of the natural silicate, is obtained in step h). A laser scattering granulometric analysis shows that this fraction corresponds to particles with size smaller than 2.0 micrometers. A determination of the specific surface of this nanoreinforcement corroborates the smaller particle size of the nanoreinforcement associated to the specific surface with respect to the natural silicate raw material. Additionally, an X-ray diffraction analysis confirms a laminar structure, a interlamellar spacing in the nanometer range and the mineral composition of this nanoreinforcement, which comprises only the phyllosilicate montmorillonite free from the other mineral components of the natural silicate used as raw material. The determined cationic exchange capacity (CEO) of the nanoreinforcement ranges from 80-90 (milliequivalents/100 g). Finally, the control of the elemental composition of the nanoreinforcement and the natural volcanic silicate prove that the aforementioned procedure does not alter the composition or introduces new elements.

### Procedure 2

Use of the nanoreinforcement of this invention to obtain polyolefin-based nanocomposites

This comprises the following steps:
a) Preparation of the modified or hybrid nanoreinforcement by cation exchange reaction in aqueous medium and temperatures between 20 and 25° C. with a quaternary amine such as octadecylamine (ODA) in an acid environment (pH 2.8-3.2). The cation exchange reaction comprises replacing exchangeable cations of the natural silicate by the quaternary amine obtained by acid treatment of ODA.
b) Preparation of the Masterbatch, which comprises mixing the hybrid nanoreinforcement, a compatibilizer such as polypropylene (PP) grafted with maleic anhydride (PP-g-MA; 0.5-1.0% of graft by weight). This mixture containing a 30/30/40 proportion of hybrid nanoreinforcement/compatibilizer/PP is carried out in a discontinuous mixer at 75-90 rpm, 185-190° C. for 10-15 minutes under an inert gas flow, such as e.g. nitrogen.
c) Preparation of the nanocomposite by diluting the Masterbatch with polyolefin in melt state using the discontinuous mixer of step b), with a 3-5% of nanoreinforcement by weight in the final mixture.

Step (a) comprises mixing a nanoreinforcement suspension in deionized water with an aqueous solution of the modifier, such as octadecylamine (ODA), at room temperature (20-25° C.), mechanically stirring for 1.5-2.0 hours at pH 2-3. The suspension contains the nanoreinforcement (8-12 g) in deionized water (0.8-1.0 l) at room temperature (20-25° C.) and at pH=2-3. The aqueous ODA solution is prepared by dissolving ODA in deionized water at room temperature (20-25° C.) and pH 2-3. When the mixing time of the aqueous nanoreinforcement suspension and the ODA aqueous solution is over, the solid is separated by centrifugation (5-10 minutes, 4000-5000 rpm), Dried (100-120° C., 20-24 hours), disaggregated in a blade mill and sieved through a 250 micrometer mesh (Test Sieve 250 μm ASTM E-11). This methodology is similar to that described in the Patent CL 2730-2006 of the authors of this patent, and is applicable to smectite-like silicates such as montmorillonite.

The preparation of the Masterbatch in step (b) is carried out in a discontinuous mixer in melt state at temperatures between 185-190° C., for 10-15 minutes and with stirring at 75-90 rpm. The Masterbatch components are: the hybrid nanoreinforcement of this invention, i.e. an ODA-modified nanoreinforcement, a commercial PP-g-MA compatibilizer, a polyolefin and antioxidants (such as e.g. Petroquim S.A.'s pentaerythritol-tetrakis[3,5-diterbutyl-4-hidroxyphenyl)-propionate] (Irganox 1010®) and tri(2,4-di-t-butyl-phenyl)phosphite (Irgafox 168®) in a 2/1 relation, in a 1/1 relation. The percentage proportion by weight of hybrid nanoreinforcement, compatibilizer and polyolefin is 30/30/40% by weight in the Masterbatch. The antioxidant composition in the Masterbatch could range between 0.02-0.03% by weight of the total mass in the Masterbatch. This methodology is similar to that described in Patent CL 2729-2006 of the authors of this invention.

The preparation of clay nanocomposites in step (c) comprises mixing the Masterbatch by dilution with polyolefin in melt state in the discontinuous mixer with controlled temperature, time and stirring conditions (180-190° C., 10-15 min, 75-90 rpm) under an inert gas flow, such as nitrogen, to replace the oxidant environment (air) in the mixing chamber and avoid the oxidation of the polyolefin. The result of this process is the production of nanocomposites with a high degree of clay exfoliation, i.e. a system composed of nanoreinforcement sheets well dispersed in the polymeric matrix. The amount of nanoreinforcement is in the range of 1-5% of nanoreinforcement by weight in the polyolefin matrix. Additionally, antioxidants were used in the nanocomposite formulation at 0.02-0.03% by weight.

### APPLICATION EXAMPLES

### Example 1

Methodology to Obtain a Nanoreinforcement from a Natural Laminar Silicate from a Volcanic Source

The nanoreinforcement produced in this invention comprises the laminar phyllosilicate sodium montmorillonite, with an interlamellar spacing in the nanometer range and particle size smaller than two micrometers. The raw material used is a natural volcanic silicate, also using: i) deionized water, ii) a deflocculant such as analytical-grade sodium hexametaphosphate, and iii) an flocculant such as analytical-grade magnesium chloride.

In this example, the steps to produce the nanoreinforcement from a volcanic silicate are described, which comprises separating silicate particles smaller than two micrometers and isolating the montmorillonite from the mineral components containing the natural volcanic silicate. For this:
1. a suspension of 10 grams of natural silicate in 700 ml of deionized water (temperature of 20° C.) is prepared with mechanical stirring for 20 minutes,
2. 25 ml of an aqueous solution of 0.5 mol/l sodium hexametaphosphate are added to the natural silicate suspension and the suspension is homogenized with mechanical stirring for 30 minutes, followed by sonication during 5 minutes, repeating this homogenization cycle of the aqueous solution of the natural silicate with the deflocculant up to 3 consecutive times,
3. the homogenized natural silicate suspension is diluted with deionized water up to a volume of 1.0 liter in a cylindrical graduated beaker with subsequent mechanical stirring for 20 minutes at 20° C., and left to stand for 21 hours,
4. the volume of the standing suspension corresponding to the top 20 cm of liquid height is extracted by suction from the top of the beaker,
5. 25 ml of a 0.5 mol/l magnesium chloride solution (flocculant) is added to the volume of extracted suspension and the remaining solution is mechanically stirred for 30 minutes and left to stand for 35 minutes,
6. the solid of the extracted solution is extracted by centrifugation for 5 minutes at 5000 rpm, and subsequently dried at 120° C. for 12 hours, deagglomerated in a blade mill and sieved through a 250 micrometer sieve (Test Sieve 250 μm ASTM E-11).
7. successive extractions of the suspension fraction containing the lower size particles according to step 4 could be repeated with the remaining solution from the first extraction. For this, the remaining solution is homogenized again with mechanical stirring for 30 minutes followed by sonication for 5 minutes and continuing with steps 3 to 6. This extraction cycle was repeated five times in this case, and six extractions with the same mass as in step 1 were additionally obtained.

This nanoreinforcement was characterized by X-ray diffraction (XRD) analysis to assess the laminar structure, determine the interlamellar spacing and the mineral composition.

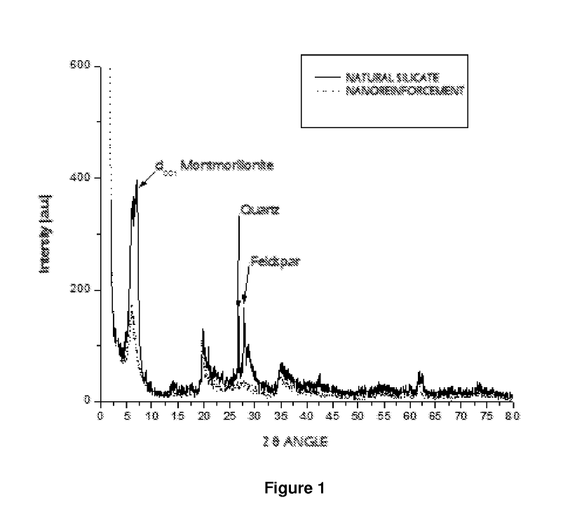

FIG. 1 shows the XRD, with the relative intensity in arbitrary units of X-rays diffracted by the powder in the Y-axis and the two-theta (2θ) angle in degrees in the X-axis, for the nanoreinforcement obtained by the process described in this application example, together with the XRD for the natural volcanic silicate used as raw material.

FIG. 1 shows that the nanoreinforcement and the natural silicate have a similar laminar structure with a relative intensity maximum corresponding to the same two-theta angle (7.08°), i.e. a interlamellar spacing of 1.25 nanometers. Additionally, FIG. 1 shows that the mineral composition of the nanoreinforcement corresponds mainly to the phyllosilicate montmorillonite, whereas the natural silicate also shows other intensity peaks corresponding to quartz and feldspar.

Other determined properties shows that the specific surface of the nanoreinforcement is larger than that in the natural silicate used as raw material, i.e. if microporosity is similar, this specific surface increase would correspond to lower size particles, hence proving that the nanoreinforcement comprises smaller sized particles, which are smaller than 2.0 micrometers as indicated by the laser scattering granulometric analysis. Smaller particles with a size lower than 2.0 micrometers are characteristic of a smectite-like clay mineral, and furthermore a lower particle size promotes a better dispersion and/or homogenization in the polymeric matrix. Additionally, the cation exchange capacity (CEO) of the nanoreinforcement is higher than that of the natural silicate, thus demonstrating that said nanoreinforcement comprises only a phyllosilicate such as montmorillonite, and the CEO would correspond to the mineral phyllosilicate and is not altered or decreased by the presence of other minerals with different CEO, such as the volcanic silicate. Table 1 summarizes these properties.

TABLE 1
Specific surface (m²/g) and cation exchange capacity (CEC) of the natural
silicate and the nanoreinforcement of the present invention

| Property | Natural silicate | Nanoreinforcement |
|---|---|---|
| Specific surface (m²/g) | 36.8 | 99.2 |
| CEO (meq/100 g) | 80.0 | 85.0 |
| Fraction under 2 μm (% by weight) | 40-50 | 89-95 |
| Fraction between 2 and 50 μm (% by | 30-39 | 1-5 |
| weight) | | |
| Interlamellar distance (nm) | 1.20 | 1.25 |

The elemental composition of the natural volcanic silicate, presented in Table 2, is similar to that of the nanoreinforcement of this invention, which shows that the manufacturing process does not alter the elemental composition due to the use of analytical-grade chemicals. Furthermore, Table 2 summarizes the elemental composition of the commercial nanoreinforcement sodium cloisite (Cloisite-Na, from Southern S.A.), showing that the nanoreinforcement of this invention has a characteristic elemental composition that is lower than in cloisite-Na. Additionally, Table 3 summarizes the mineral composition of silicate minerals, and shows that this process produces an isolate containing the phyllosilicate montmorillonite, as corroborated by the XRD analysis showing mainly the refracted light intensity characteristic of montmorillonite (FIG. 1).

TABLE 2
Elemental composition (% by weight) of the natural volcanic silicate

| | | | Cloisite-Na |
|---|---|---|---|
| | Natural silicate | Nanoreinforcement | (Southern) |
| SiO₂ | 53.52 | 53.48 | 55.92 |
| Al₂O₃ | 15.31 | 15.20 | 19.20 |
| Na₂O | 2.43 | 2.45 | 3.84 |
| Li₂O | 0.02 | 0.02 | n.d. |
| Fe₂O₃ | 1.33 | 1.30 | 4.28 |
| MgO | 5.14 | 5.12 | 2.09 |
| CaO | 1.32 | 1.30 | 0.14 |
| K₂O | 0.73 | 0.70 | 0.10 |

Additionally, the weight yield of each cycle of extraction of the finest fraction from the natural silicate according to the procedure described in this application example of the nanoreinforcement in step 7 was verified by weighting the dried solid extracted in each cycle. Table 4 summarizes the results obtained from five extraction cycles in duplicate. According to the results in Table 4, after five cycles the yield is around 58-63% by weight of the finest fraction of the natural silicate smaller than 2 micrometers and corresponding to the nanoreinforcement obtained in this invention. Table 4 shows a yield of 6.211 or 5.806 g from 10 g of natural silicate, which corresponds to a percent yield around 58-63%.

TABLE 3
Mineral composition (% by weight) of the natural volcanic silicate

| Mineral | Composition (% by weight) |
|---|---|
| Montmorillonite (phyllosilicate) | 90.3 |
| Illite (phyllosilicate) | 3.6 |
| Quartz | 4.3 |
| Feldspar | 1.4 |
| Plagioclase | 0.1 |
| Clinoptilolite | 0.2 |
| Amphiboles | 0.1 |

TABLE 4
Weight yield (grams) of five extraction cycles of the fraction under two
micrometers from initial 10 grams of natural silicate:
duplicate assays (A and B)

| | A | B |
|---|---|---|
| Extraction | Mass (g) | Mass (g) |
| 1 | 2.368 | 1.759 |
| 2 | 1.210 | 1.174 |
| 3 | 1.636 | 1.594 |
| 4 | 0.737 | 0.917 |
| 5 | 0.260 | 0.362 |
| Total | 6.211 | 5.806 |

### Example 2

Methodology to Produce Polyolefin-Based Nanocomposites with the Nanoreinforcements of this Invention

The polyolefin nanocomposite and the use of the nanoreinforcement of this invention is constituted by the following raw materials>
(i) The commercial polyolefins used were Ziegler-Natta polypropylene (PP) homopolymers from Petroquim S.A. with fluidity indexes (FI) of 3, 13 and 26 (ZN450, ZN250 and ZN150) with the properties described in Table 5.

TABLE 5
Fluidity index (F), average molecular weight ( M̅w̅), polydispersity
(P_{d}), elastic modulus (E), elastic limit (σ_{y}), break
deformation (ε) of Ziegler-Natta (ZN) PP used in the invention

| | | M̅w̅ | Pd | E | σ_{y} | ε |
|---|---|---|---|---|---|---|
| PP | FI | (Kg/mol) | ( M̅w̅/ M̅n̅) | (MPa) | (MPa) | (%) |
| ZN 450 | 1 | 450 | 3.9 | 1,160 ± 30 | 32 ± 1 | 600 |
| ZN 250 | 13 | 250 | 3.4 | 1,080 ± 40 | 30 ± 2 | 100 |
| ZN 150 | 26 | 150 | 4.4 | 1,092 ± 45 | 32 ± 2 | 20 |

(ii) Nanoreinforcement of this invention with properties summarized in Tables 1 and 2.
(iii) Compatibilizer: PP ZN 250 with FI=13 grafted with maleic anhydride (MA) with a graft percentage of 1% by weight of MA (Polybond 3002, Uniroyal, PP-g-MA).
(iv) Antioxidant: beta-hydroxytoluene (BHT) and pentaerythritol-tetrakis[3-(3,5-diterbutyl-4-hydroxyphenyl)-propionate] (Irganox 1010®) and tri-(2,4-di-t-butyl-phenyl) phosphite (Irgafox 168®) in 2/1 proportion, from Petroquim S.A.

This example describes the steps to obtain a ZN 450 polypropylene nanocomposite with 5.0% by weight of hybrid nanoreinforcement (or hybrid montmorillonite, Mo) using a Masterbatch with hybrid montmorillonite and a commercial PP-g-MA compatibilizer with 1% of MA graft, having a relation of hybrid Mo/PP-g-MA/PP of 30/30/40% by weight, for a total mass of 35 g equivalent to the capacity of the discontinuous mixer used, comprising:
a) Production of the hybrid nanoreinforcement by the methodology described in procedure 1 a, generally comprising the following steps:
i. producing a nanoreinforcement suspension (10 g/l) in deionized water by mechanical stirring for 30 minutes at 22° C. (suspension 1),
ii. dissolving 3.2 grams of the organic compound octadecylamine (ODA) in 1 liter of deionized water at 22° C. and adjusting the pH to 3.0 with an inorganic acid such as hydrochloric acid (solution 1),
iii. adding solution 1 to suspension 1 and mixing by mechanical stirring for 2 hours at 22° C. (suspension 2),
iv. separating the solid content of suspension 2 by centrifugation at 5000 rpm for 5 minutes at 10° C.,
v. drying the solid obtained in step (iv) for 12 hours at 120° C.,
vi. washing the solid obtained in step (v) with deionized water to completely remove chloride ions (silver nitrate test) in the remaining liquid from the suspension, separating the solid by centrifugation and then drying at 120° C. for 12 hours,
vii. deagglomerating the dry solid from step (vi) with a blade mill and sieving through a 250 micrometers sieve (Test Sieve 250 um ASTM E-11).
b) preparing a Masterbatch, which comprises mixing 10.5 grams of the hybrid nanoreinforcement obtained in step a), 10.5 grams of PP-g-MA compatibilizer (1% grafted MA), 21.0 grams of polypropylene ZN340, 0.02 grams of BHT and 0.02 grams of Irganox 1010® as antioxidants. This mixture is carried out in a discontinuous mixer at 80 rpm and 190° C. for 10 minutes under an inert gas flow, such as e.g. nitrogen,
   Producing the nanocomposite: this comprises mixing 0.58 grams of Masterbatch with a mixture of hybrid Mo and PP-g-MA compatibilizer in a 30/30% by weight ratio of hybrid Mo/PP-g-MA, produced in step (b), 34.38 grams of ZN450 polypropylene, 0.02 grams of BHT and 0.02 grams of Irganox 1010®/Irgafox as antioxidants. This mixture is carried out in a discontinuous mixer at 190° C., 80 rpm for 10 min and under an inert gas flow such as nitrogen, in order to displace the oxidant air environment from the chamber and avoid the degradation of polypropylene. The nanocomposite thus produced contains 5% by weight of hybrid nanoreinforcement or hybrid Mo in the polymeric matrix.

The same procedure already described in this application Example 2 is valid for nanocomposites produced using other silicates such as ODA-modified sodium cloisite (Southern SA), as well as nanoreinforcements such as Mo clay interspersed with methyl-octadecyl-itaconate (MODIT) monomer or itaconic acid (ITA) monomer, with different PP such as ZN250 and ZN150, together with the compatibilizer PP-g-ITA or PP-g-MODIT containing 0.5, 1.0 and 1.2% by weight of ITA or MODIT graft, respectively. This procedure is similar to the one described in patents CL 2729-2006 and CL 2730-2006 from the inventors of this invention, which use the aforementioned nanoreinforcements, polymers and compatibilizers.

### Mechanical, Thermal and Crystallographic Properties of the Produced Nanocomposites

The assays carried out to verify the mechanical and thermal properties, as well as the existence of exfoliation of interspersing of the nanoreinforcement in the PP (ZN450) nanocomposites and nanoreinforcements of this invention, together with a commercial montmorillonite such as sodium cloisite (Southern SA) were:
Stress-deformation assays according to ASTM D 638 to determine the tensile modulus (E) in megapascals (MPa) and the elastic deformation limit (σy) in megapascals (MPa) and break elongation (%) (Table 6).
Thermal assay by gravimetric thermal assay to get the thermal decomposition temperature evaluated as the temperature corresponding to a 50% of weight loss, codified as “T₅₀” and referred to as thermal stability (Table 7).
X-ray diffraction assays to qualitatively verify the exfoliation or interspersing state of the nanoreinforcements.

TABLE 6
Tensile modulus (E), elastic deformation limit (σ_{y})
and break elongation (ε) of nanocomposites containing
5% by weight of hybrid ODA-modified sodium montmorillonite
nanoreinforcement (Mo-ODA and CL-ODA), 3% by weight
of PP-g-MA as compatibilizer and PP (ZN450) with different
fluidity indexes as a matrix

| | Mo-ODA | | | | | |
|---|---|---|---|---|---|---|
| | | σ_{y} | | CL-ODA | | |
| PP | E (MPa) | (MPa) | ε (%) | E (MPa) | σy (MPa) | ε (%) |
| ZN 450 | 1354 ± 34 | 37 ± 1 | 25 ± 2 | 1326 ± 22 | 36 ± 1 | 52 ± 3 |
| ZN 250 | 1477 ± 35 | 37 ± 1 | 10 ± 1 | 1419 ± 32 | 36 ± 2 | 6 ± 2 |
| ZN 150 | 1604 ± 33 | 37 ± 1 | 12 ± 1 | 1589 ± 37 | 39 ± 1 | 11 ± 1 |

TABLE 7
Thermal stability of nanocomposites containing 5% by weight of ODA-
modified sodium montmorillonite (Mo-ODA and CL-ODA),
PP ZN450 as a matrix and PP-g-MA as a compatibilizer

| Matrix | Nanoreinforcement | T₅₀ (° C.) |
|---|---|---|
| PP ZN 450 | Without | 386 |
| | Mo-ODA | 491 |
| | CL-ODA | 452 |

The mechanical properties of the polyolefin nanocomposites comprising a nanoreinforcement of this invention show:
Higher rigidity or tensile modulus (E) (5 to 10% increase) and elastic deformation limit (σ_{y}) (5 to 15% increase) for polyolefin nanocomposites with hybrid or ODA-interspersed nanoreinforcements using PP-g-MA compatibilizers in comparison with the same nanocomposites using the commercial montmorillonite Cloisite-Na modified with ODA.

According to these results, the nanoreinforcement of this invention is an alternative competitive raw material to produce nanocomposites with improved mechanical properties for the same applications for nanocomposites using commercial nanoreinforcements such as sodium cloisite, i.e. in the automotive, aerospace, construction and packaging industries.

According to the thermal assays of the nanocomposites obtained using the nanoreinforcement of this invention, the thermal stability (T₅₀) is 8.6% higher than in the nanocomposites using the sodium cloisite nanoreinforcement, and both are 17 to 27% higher than that of the polymeric polyolefin ZN450 matrix.

According to these results, the nanoreinforcement of this invention is an alternative competitive raw material to produce nanocomposites with improved thermal properties for the same applications using commercial nanoreinforcements such as sodium cloisite.

### X-Ray Diffraction

The X-ray diffraction assays of the nanoreinforcement of this invention showed that:
The nanoreinforcement used in this invention can be modified or interspersed with organic compounds such as quaternary amines, just in the same way as commercial montmorillonites.
the interlamellar distance of the nanoreinforcement is in the nanometer range and this interlamellar distance is higher than that in the natural volcanic silicate, and
the nanoreinforcement of this invention is a raw material alternative to sodium montmorillonite-base nanoparticles such as commercially available smectite clays.

1. A natural nanoreinforcement useful to manufacture polymeric nanocomposites wherein said nanoreinforcement comprises in its basic structure a laminar silicate from volcanic sources.

2. The natural nanoreinforcement according to claim 1, wherein the laminar volcanic silicate contains a mixture of mineral components such as the phyllosilicates montmorillonite and illite, quartz, plagioclase, feldspar, clinoptilolite and amphiboles.

3. The natural nanoreinforcement according to claim 1, wherein the laminar volcanic silicate has an interlamellar space with hydrophilic character in the range of 1.0 to 1.5 nanometers.

4. The natural nanoreinforcement according to claim 1, wherein the laminar volcanic silicate has a mononodal granulometric distribution with a particle size ranging from 0.1 to 10 micrometers.

5. A natural nanoreinforcement according to claim 1, wherein the nanoreinforcement is a smectite silicate such as sodium montmorillonite.

6. The natural nanoreinforcement according to claim 1, wherein the nanoreinforcement comprises in its structure a silicate with particle size smaller than two micrometers, has a specific surface ranging from 85 to 100 m²/g, a cationic exchange capacity ranging from 80 to 95 meq/100 g and a crystalline structure with a hydrophobic interlamellar space that is 30-35% larger than the original silicate.

7. The natural nanoreinforcement according to claim 1, wherein the nanoreinforcement can be mixed with polymers such as polyolefins based on ethylene or propylene homopolymers, as well as copolymers of ethylene or propylene with alpha-olefins.

8. The natural nanoreinforcement according to claim 1, wherein said nanoreinforcement is useful to produce nanocomposites when mixed with polymers.

9. A process to manufacture a natural nanoreinforcement, wherein the nanoreinforcement is obtained by a process comprising the steps of:
a. preparing a volcanic natural silicate aqueous solution (5-12 g in 600-700 ml of deionized water) with mechanical stirring for 10-20 minutes at 18-23° C.,
b. adding 20-30 ml of a deflocculant (0.4-0.6 mol/l) to the suspension obtained in step (a), continuing with the mechanical stirring for 20-30 minutes, followed by sonication (5-10 minutes),
c. repeating four to six times the cycle of mechanical stirring for 20-40 minutes followed by sonication (10-20 minutes) of the suspension obtained in (b),
d. transferring the suspension obtained in (c) after finishing the agitation and sonication cycles to a beaker, adding deionized water to complete a total 1-litre volume, mechanically stirring (5-10 minutes) to homogenize the solution and leaving the solution to stand for 21-24,
e. extracting by suction the top fraction of the suspension obtained in (d),
f. adding 20-30 ml of an aqueous solution of a flocculant compound (0.3-0.6 mol/l) to the suspension obtained in (e), mechanically stirring for 20-30 minutes, and leaving to stand for 20-30 minutes,
g. separating the suspended solids in the suspension obtained in (f) by centrifugation at 4.000-5.000 rpm for 3-5 minutes and drying the solid at 100-120° C. for 20-25 hours, and
h. disaggregating the dry solid from step g) using a blade mill and sieving through a standard 250 micrometer mesh.

10. The process according to claim 9, wherein the deflocculant is sodium metaphosphate.

11. The process according to claim 9, wherein the flocculant is analytical-grade magnesium chloride.

12. The natural nanoreinforcement according to claim 1, wherein the nanoreinforcement comprises an interlamellar space having hydrophilic character and wherein the nanoreinforcement can exchange interlamellar cations with organic cations and thus change the hydrophilic character of the interlamellar space to a hydrophobic character.
